(19) United States
(12) Patent Application Publication
(10) Pub. No.: US 2018/0058145 A1
(43) Pub. Date: Mar. 1, 2018

(54) APPARATUS AND METHODS FOR ACTIVATING A DOWNHOLE PERCUSSION TOOL

(71) Applicant: National Oilwell DHT, L.P., Conroe, TX (US)

(72) Inventor: Joshua Caleb Tutt, Magnolia, TX (US)

(73) Assignee: National Oilwell DHT, L.P., Conroe, TX (US)

(21) Appl. No.: 15/686,610

(22) Filed: Aug. 25, 2017

Related U.S. Application Data
(60) Provisional application No. 62/380,121, filed on Aug. 26, 2016.

(51) Int. Cl. E21B 1/00; F04B 1/047; F15B 15/02; F15B 15/18

(52) U.S. Cl. CPC E21B 1/00; F04B 1/047; E21B 4/02; F15B 15/18; F15B 15/02

(57) ABSTRACT

A percussion tool includes an actuating piston and a pump. The pump includes: a cam ring, a valve plate, a piston housing, and a piston. The cam ring includes an aperture having a camming surface. The valve plate faces the cam ring and includes a fluid port extending therethrough. The piston housing includes a fluid passage extending therethrough and is disposed within the aperture of the cam ring and rotates within the cam ring. A piston reciprocates within the piston housing. The fluid passage in the piston housing is configured to alternate between being in fluid communication with the fluid port in the valve plate and being isolated from the fluid port as the piston housing is rotated relative to the cam ring and valve plate. The flow port in the valve plate is larger in flow area than the flow area of the fluid passage in the piston housing.

### CROSS-REFERENCE TO RELATED APPLICATIONS

This application claims benefit of U.S. provisional patent application Ser. No. 62/380,121 filed Aug. 26, 2016, and entitled “Apparatus and Methods for Activating a Downhole Percussion Tool,” which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to downhole tools and equipment used in the recovery of oil and gas. More particularly, it relates to an apparatus and a system to generate an impact force within a tool. Still more particularly, this disclosure relates to an impact-generating tool suitable for use in the bottom hole assembly of a tubular string deployed in an oil well, the tool configured to enhance the rate of penetration through the formation that is being drilled.

While drilling a wellbore, percussion tools are sometimes employed to generate an axial motion of a component that is converted to an axially-directed force that, in turn, is applied to a downhole drilling device, such as a drill bit. The application of such a percussive force to a bit may serve to reduce the undesirable effect of friction on the drill string and increase the rate of penetration of the bit. Many conventional percussion tools include a drive connection that mechanically converts rotational drive motion to axially-directed percussive motion. Such motion is typically created by cams and roller that cooperate first to mechanically “lift” an assembly away from the component that is to be impacted and, subsequently, to allow the assembly to “fall back” and impact the component, which then transfers the percussion to the drill bit. The “lift” and subsequent “collapse” may occur multiple times per revolution. However, many such arrangements suffer from low life. The main area of failure is in the components that mechanically life or extend the tool, including the cams and rollers. The high contact stresses and friction tend to quickly wear these components. Debris is sometimes generated which can migrate within the tool and cause collateral damage. A mechanism and method that would provide an alternate means to create the percussive effect and provide longer life and greater reliability would be welcomed in the industry.

### SUMMARY OF THE DISCLOSURE

Embodiments disclosed herein include a percussion tool employing a positive displacement pump having radially-arranged pistons which cooperate to cause percussion surfaces first to separate and then fall into contact. The pump includes a cam ring coupled to a tool housing. Pistons engage the cam ring and are pushed radially inward by the cam ring to pump fluid. The pumped fluid flows through a passage and acts on an actuation piston. The pressure created by the pump extends or lifts the tool, separating the percussion surfaces. Upon rotation of the piston's housing, a fluid port comes into alignment with an intake port. When this occurs, the fluid action on the actuation piston is released and the tool collapses and creates the percussive force. As the piston housing rotates further, the pistons extend and fluid is sucked into the piston cylinder, and the cycle repeats. This arrangement beneficially avoids impact loading on the cams. Further, multiple, axially-spaced stages of the pistons can be used to spread the load. Rolling contact between the piston and cam is possible.

In more detail, in one embodiment, a percussion tool that is configured to be coupled to a drill string includes a housing and an upper and lower mandrel, each mandrel having at least a first end disposed in the housing. The second end of the lower mandrel is configured to couple to a drilling tool. A connector in the housing is configured to transfer rotation to the lower mandrel when the upper mandrel is rotated. An actuating piston in the housing is configured to reciprocate axially in the housing and to cause the lower mandrel to reciprocate axially relative to the upper mandrel. The tool further includes a pump disposed in the housing and comprising: a cam ring including an end surface and an aperture having a camming surface; a valve plate having an end surface disposed opposite the end surface of the cam ring and having at least one fluid port extending through the valve plate; a piston housing disposed within the aperture of the cam ring and configured to rotate within the cam ring upon rotation of the upper mandrel, wherein the piston housing comprises at least one fluid passage extending therethrough. A piston is configured to reciprocate within the piston housing. A fluid passage in the piston housing is configured to alternate between being in fluid communication with the fluid port in the valve plate and being isolated from the fluid port as the piston housing is rotated relative to the cam ring and valve plate.

In some embodiments, the tool further includes a roller coupled to the piston and configured to engage the camming surface of the cam ring.

In some embodiments, the flow port in the valve plate is larger in flow area than the flow area of the fluid passage in the piston housing and, in some embodiments, the cross-sectional flow area of the fluid port is non-circular in the valve plate.

In some embodiments, the percussion tool further includes: a plurality of fluid ports in the valve plate; a plurality of fluid passages in the piston housing; wherein each fluid passage in the piston housing is configured to alternate between being in fluid communication with one of the fluid ports in the valve plate and thereafter being isolated from the same fluid port as the piston housing is rotated relative to the cam ring and valve plate.

The percussion tool may further include a variable volume annular chamber disposed between the actuating piston and the piston housing and configured to change volume based on the movement of actuating piston. In such arrangement, the fluid passages of the piston housing extend between the annular chamber and the valve plate, and the fluid passages provide intermittent fluid communication between the annular chamber and the fluid ports in the valve plate as the piston housing is rotated. In some embodiments, the fluid passages are configured to provide uninterrupted fluid communication between the piston in the piston housing and the annular chamber, and uninterrupted fluid communication between the piston in the piston housing and the actuating piston.

A pump is disclosed herein that, in some embodiments, includes: a cam ring; an annular valve plate; an annular piston housing; and a plurality of pistons. The cam ring includes an end surface, an aperture, and a camming surface within the aperture. The annular valve plate is fixed in position with respect to cam ring and includes and end surface opposing the end surface of the cam ring, and includes at least two fluid ports extending therethrough. The annular piston housing is disposed within the aperture of the cam ring and includes: a plurality of fluid passages extending through the piston housing, an outer surface, and a plurality of radially extending cylinder bores extending through the outer surface, wherein each cylinder bore is in fluid communication with one of the fluid passages. Each piston is slidingly received in one of the cylinder bores and configured to reciprocate radially in the piston housing. Each piston defines a variable volume cylinder chamber that is in fluid communication with one of the fluid passages. The pump is configured such that as the piston housing is rotated relative to the cam ring and valve plate, a first of the fluid passages in the piston housing sequentially aligns with a first of the fluid ports in the valve plate and thereafter aligns with a solid portion of the valve plate such that the fluid passage becomes isolated from fluid communication with all fluid ports of the valve plate.

In some embodiments, the pump is configured such that each fluid passage in the piston housing sequentially aligns with each fluid port in the valve plate during repeating pumping cycles, each fluid passage alternating between being in fluid communication with one of the fluid ports followed by being isolated from fluid communication with all the fluid ports.

In some embodiments, the flow area of each fluid port in the valve plate is larger than the flow area of each fluid passage in the piston housing and, as the piston housing is rotated, the flow area of the first fluid passage progressively aligns with a changing portion of the flow area of the first fluid port. The cross-sectional flow areas of the fluid ports are non-circular in some embodiments.

In some embodiments, the pump further includes a load driven by the pump wherein, as the piston housing is rotated, the load is always in fluid communication with the pistons via the fluid passages. The pump may be configured such that the path of fluid communication between the pistons and the load is free of valves.

In some embodiments, the load and the pistons are periodically in fluid communication with the fluid ports of the valve plate via the fluid passages, the fluid communication taking place when the fluid passages align with the fluid ports. In some embodiments, each fluid port is configured to provide fluid flow both to and from the aligned fluid passage. Further, in some embodiments, each fluid port is configured to provide fluid flow both to and from the aligned fluid passage without losing fluid communication between the time period of flow to the aligned fluid passage and time period of the flow from the aligned fluid passage.

There is further disclosed a percussion tool comprising: a housing; upper and lower mandrels; a connector in the housing coupling the mandrels and configured to transfer rotation to the lower mandrel when the upper mandrel is rotated. The tool further includes an actuating annular piston in the housing disposed about the upper mandrel and configured to reciprocate axially in the housing and to cause the lower mandrel to reciprocate axially relative to the upper mandrel. A pump is disposed in the housing and includes: a cam ring rotationally and axially fixed with respect to the housing; an annular valve plate; an annular piston housing; a plurality of pistons in the piston housing; and a roller coupled to each piston. The cam ring including an aperture, a camming surface that defines the aperture, and an axially facing end surface facing in a direction away from the actuating piston. The annular valve plate is rotationally and axially fixed with respect to the housing and is disposed about the upper mandrel, and includes an end surface facing the end surface of the cam ring. The valve plate further includes at least two fluid ports extending axially therethrough. The annular piston housing of the pump is disposed within the aperture of the cam ring and disposed about and rotationally fixed to the upper mandrel, the piston housing, and the upper mandrel. The annular piston housing is configured to rotate within the cam ring upon rotation of the upper mandrel, and includes a plurality of axially-extending fluid passages. The pistons are disposed in the piston housing and configured to reciprocate radially. The roller engages the camming surface of the cam ring. Each fluid passage in the piston housing is configured to alternate between being in fluid communication with any one of the fluid ports in the valve plate and being isolated from the same fluid port as the piston housing is rotated relative to the cam ring and valve plate.

In some embodiments, the axially facing flow areas of the fluid ports in the valve plate is larger than the axially facing flow areas of the fluid passages in the piston housing; and as the piston housing is rotated, the flow area of each fluid passage progressively aligns with a changing portion of the flow area of the mating fluid port.

In some embodiments, a variable volume annular chamber extends between the actuating annular piston and the piston housing and is configured to change volume based on the movement of actuating annular piston and, the fluid passages of the piston housing are disposed between the annular chamber and the valve plate, the fluid passages providing periodic fluid communication between the annular chamber and the sequentially aligned fluid ports in the valve plate.

In some embodiments, the piston housing further comprises a plurality of radially extending cylinder bores, each cylinder bore receiving and slidingly engaging the one of the pistons therein, and each cylinder bore intersecting one of the axial fluid passages. In this arrangement, the plurality of pistons and the actuating annular piston are always in fluid communication through a variable volume pumping chamber comprising: a lower portion of each cylinder bore; the fluid passages of the piston housing; and the annular chamber.

In some embodiments, the cam ring is rotationally and axially fixed with respect to the annular valve plate and the housing.

In some embodiments, the camming surface of the cam ring is configured so that the rollers maintain in contact with the camming surface throughout a full 360 degree rotation of the annular piston housing with respect to the cam ring.

### BRIEF DESCRIPTION OF THE DRAWINGS

For a detailed description of the disclosed exemplary embodiments, reference will now be made to the accompanying drawings, in which:

FIG. 1 is a schematic elevation view of an embodiment of a well drilling system having a downhole percussion tool in accordance with principles disclosed herein.

FIG. 2 is a cross-sectional side view of the percussion tool of FIG. 1;

FIG. 3 is a close cross-sectional side view of a portion of the percussion tool of FIG. 2 in the region A-A, including an internal pump and an actuating annular piston;

FIG. 4 is an end view of the pump of FIG. 3;

FIG. 5 is shows an end view of the annular valve plate and cam ring of the pump of FIG. 3;

FIG. 6 is a perspective view of the pump of FIG. 4 from the opposite end;

FIG. 7 is a cross-sectional side view of the pump of FIG. 4;

FIG. 8 is an end view of the pump of FIG. 4 with hidden lines indicating features of the piston housing and of the valve plate, with the piston housing shown located at a first radial position relative to the cam ring and valve plate;

FIG. 9 is an end view of the pump of FIG. 4 with the piston housing shown located at a second radial position relative to the cam ring and valve plate;

FIG. 10 is an end view of the pump of FIG. 4 with the piston housing shown located at a third radial position relative to the cam ring and valve plate;

FIG. 11 is an end view of the pump of FIG. 4 with the piston housing shown located at a fourth radial position relative to the cam ring and valve plate;

FIG. 12 is an end view of the pump of FIG. 4 with the piston housing shown located at a fifth radial position relative to the cam ring and valve plate;

FIG. 13 is an end view of the pump of FIG. 4 with the piston housing shown located at a sixth radial position relative to the cam ring and valve plate; and

FIG. 14 shows another embodiment of a pump suitable for use in the percussion tool of FIG. 2 in accordance with principles described herein.

### NOTATION AND NOMENCLATURE

The following description is exemplary of certain embodiments of the disclosure. One of ordinary skill in the art will understand that the following description has broad application, and the discussion of any embodiment is meant to be exemplary of that embodiment, and is not intended to suggest in any way that the scope of the disclosure, including the claims, is limited to that embodiment.

The figures are not necessarily drawn to-scale. Certain features and components disclosed herein may be shown exaggerated in scale or in somewhat schematic form, and some details of conventional elements may not be shown in the interest of clarity and conciseness. In some of the figures, in order to improve clarity and conciseness, one or more components or aspects of a component may be omitted or may not have reference numerals identifying the features or components. In addition, within the specification, including the drawings, like or identical reference numerals may be used to identify common or similar elements.

As used herein, including in the claims, the terms “including” and “comprising,” as well as derivations of these, are used in an open-ended fashion, and thus should be interpreted to mean “including, but not limited to . . . .” Also, the term “couple” or “couples” means either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, then X may be based on Y and on any number of other factors. The word “or” is used in an inclusive manner. For example, “A or B” means any of the following: “A” alone, “B” alone, or both “A” and “B.”

In addition, the terms “axial” and “axially” generally mean along or parallel to a given axis, while the terms “radial” and “radially” generally mean perpendicular to the axis. For instance, an axial distance refers to a distance measured along or parallel to a given axis, and a radial distance means a distance measured perpendicular to the axis. Furthermore, any reference to a relative direction or relative position is made for purpose of clarity, with examples including “top,” “bottom,” “up,” “upward,” “down,” “lower,” “clockwise,” “left,” “leftward,” “right” “right-hand,” “down”, and “lower.” For example, a relative direction or a relative position of an object or feature may pertain to the orientation as shown in a figure or as described. If the object or feature were viewed from another orientation or were implemented in another orientation, it may be appropriate to describe the direction or position using an alternate term.

In regard to a borehole or equipment that is intended for use in a borehole, “up,” “upper,” “upwardly” or “upstream” means toward the surface of the borehole and “down,” “lower,” “downwardly,” or “downstream” means toward the terminal end of the borehole, regardless of the borehole's physical orientation.

### DETAILED DESCRIPTION OF THE DISCLOSED EXEMPLARY EMBODIMENTS

This disclosure describes a pump and a percussion tool which can be employed to create vibration and movement in a down hole tool to enhance the tool's rate of penetration through the formation.

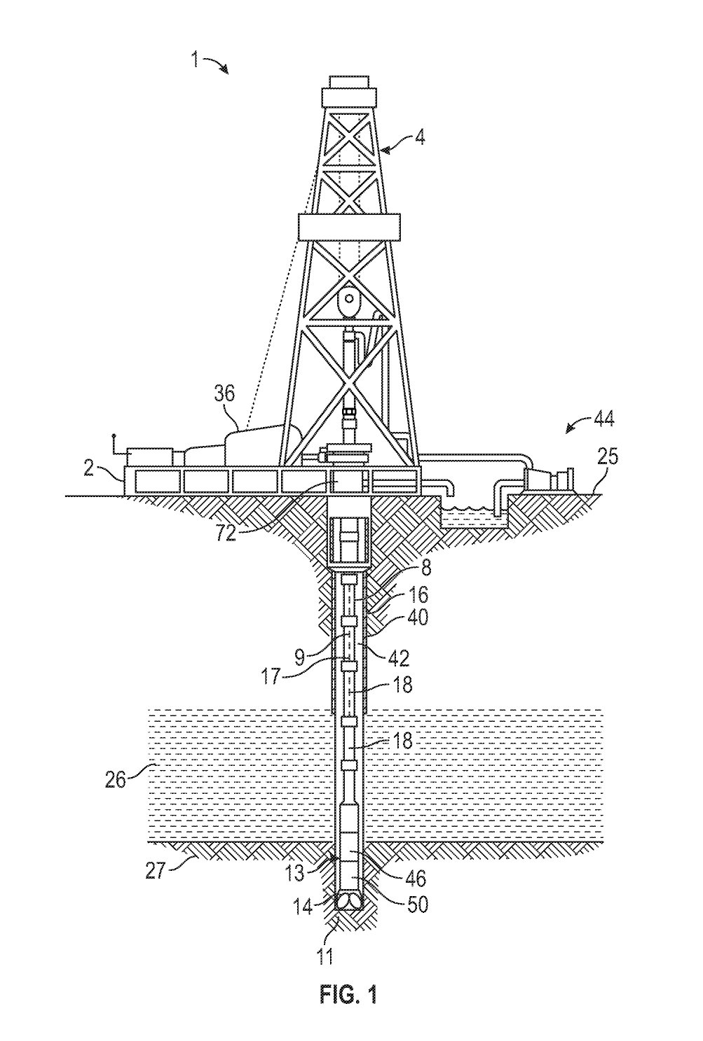

FIG. 1 is a schematic diagram showing an embodiment of a well system in accordance with principles described herein. Well system 1 includes a tubular string 8 (e.g., drill string, production tubing string, coiled tubing, etc.) to accomplish downhole operations. In the example shown, tubular string 8 is a drill string, and well system 1 is a drilling system that includes a derrick 4 supported by a drilling platform 2. Although FIG. 1 shows a land-based drilling system, the present disclosure is also applicable to off-shore well drilling systems.

The drill string 8 extends downward and comprises a longitudinal axis 9 and various components, including one or more tubular members 18 (i.e. pieces of drill pipe, which may also be called a pipe joint) coupled together end-to-end and extending along axis 9, a bottom-hole-assembly (BHA) 13 coupled to the lowest tubular member 18, and a drill bit 14 coupled to the lower end of BHA 13. The drill bit 14 is coupled to and forms the distal end of the drill string 8. With weight applied to the drill string, bit 14 is rotated by known means and the bit disintegrates subsurface formations to drill the borehole 16, which may also be called a well bore. Borehole 16 comprises a generalized centerline or longitudinal axis 17 and may pass through multiple subsurface formations or zones 26, 27. The drill string axis 9 may be generally aligned with borehole axis 17, at least in various places or during some time periods of operation.

Referring still to FIG. 1, as drilling progresses, the borehole 16 penetrates a subsurface formation, zone, or reservoir, such as reservoir 11 in subsurface formation 27 that is believed to contain recoverable hydrocarbons. A tubular casing 40 is installed and extends downward generally from the earth's surface 25 and into at least a portion of borehole 16. Tubular casing 40 isolates various vertically-separated earthen zones, such as zones 26, 27, preventing fluid transfer between the zones. An annular space or annulus 42 is formed between the outer surface of drill string 8 and the inner surface of the casing 40, and, at locations where casing 40 is not installed, annulus 42 extends between the outer surface of drill string 8 and the sidewall of borehole 16. A drilling fluid circulation system 44 pumps drilling mud down through drill string 8 and bit 14, and then back to the surface through annulus 42 to remove cuttings and, optionally, for other purposes, such as to drive a mud motor 46 within BHA 13 when operators choose to rotate drill bit 14 using the mud motor. A percussion tool 50 at the lower end of BHA 13 includes internal components configured to expand and collapse short axial distances in order to vibrate drill string 17 and drill bit 14, thereby improving the performance of well system 1.

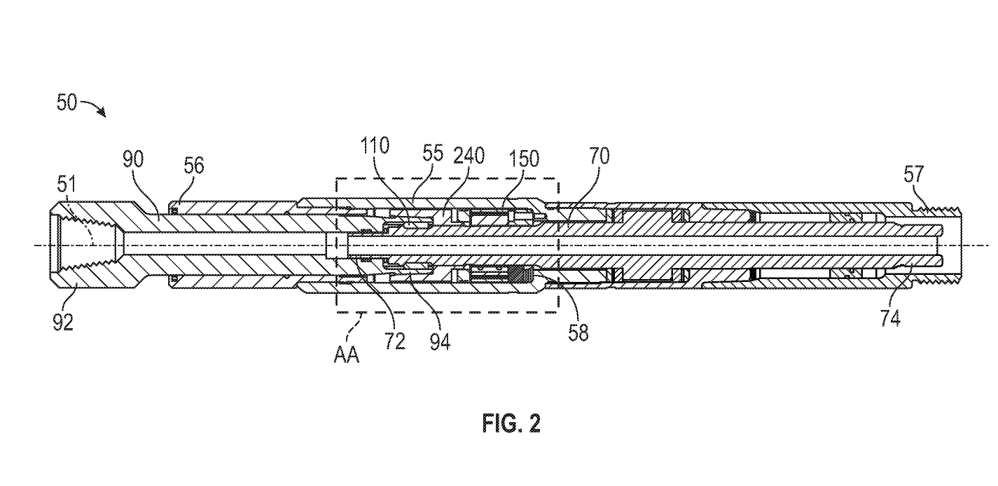

Referring now to FIG. 2, in an exemplary embodiment, percussion tool 50 includes a longitudinal axis 51, a collar or tubular outer housing 55, a tubular upper mandrel 70, and a tubular lower mandrel 90 coupled to mandrel 70 by a torque coupling 110. Tool 50 also includes a pump 150 received between housing 55 and upper mandrel 70, an actuating annular piston 240 positioned between pump 150 and lower mandrel 90, and a piston seal ring 260 positioned between pump 150 and piston 240. Pump 150 is configured to move a working fluid in order to displace axially the lower mandrel 90 with respect to the upper mandrel 70, periodically. The working fluid is separate from the drilling fluid, i.e. the mud, flowing through the center of string 8. As an example, the working fluid of pump 150 is an oil. Herein and in the claims, the working fluid of pump 150 may also simply be called, “fluid.”

Housing 55 is aligned with tool axis 51 and includes a leading or lower end 56, a trailing or upper end 57 spaced apart from lower end 56 along axis 51, and an internal shoulder 58 located between ends 56 and 57 and facing lower end 56. In FIG. 2, housing 55 is formed from multiple tubular parts coupled by threads, but the tubular parts may be coupled by other known means.

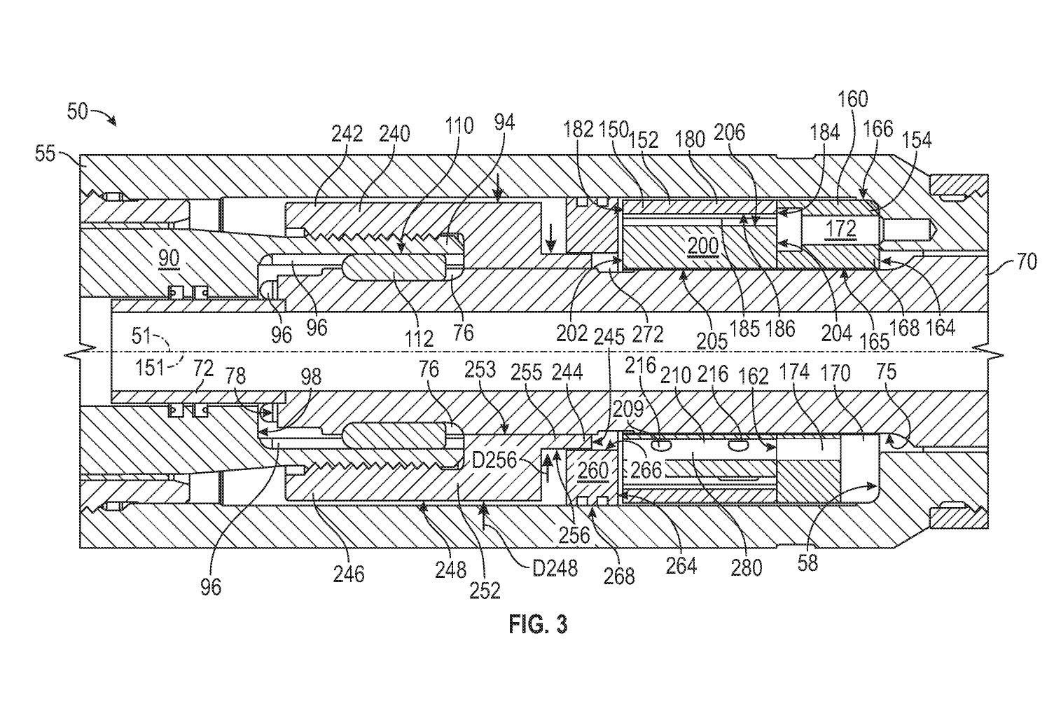

Referring to both FIG. 2 and FIG. 3, upper mandrel 70 is aligned with tool axis 51 and includes a leading or lower end 72, a trailing or upper end 74 spaced apart from lower end 72 along axis 51, and outer surface 75, and, best shown in FIG. 3, a plurality of axial channels 76 circumferentially spaced about the outer surface 75 proximal lower end 72. Channels 76 form part of torque coupling 110. Between channels 76 and lower end 72, an external shoulder forms a percussion surface 78.

Lower mandrel 90 is aligned with tool axis 51 and includes a leading or lower end 92, a trailing or upper end 94, and a plurality of axial channels 96 circumferentially spaced about the inner surface mandrel 90 and extending inward from upper end 94, and an internal shoulder forming a percussion surface 98 spaced apart from upper end 94 approximately by the length of channels 96. Lower end 92 extends beyond the lower end of housing 55 and is configured to couple threadingly the drill bit 14 so as to transfer torque for rotation and axial movement.

Referring again to FIG. 1, in the assembly of tubular string 8, the upper end 57 of tool housing 55 is threadingly coupled to another portion of the BHA 13 that includes mud motor 46, and the upper end of upper mandrel 70 threadingly couples mud motor 46 to be rotated by mud motor 46. Coupled together, BHA 13 and tubular string 8 rotates when the tubular string 8 is rotated. The upper and lower mandrels 70, 90 are configured to rotate independently of housing 55 when mud motor 46 drives them; otherwise, mandrels 70, 90 may rotate along with housing 55.

As best shown in FIG. 3, a torque coupling 110 joins upper end 94 of lower mandrel 90 with lower end 72 of upper mandrel 70 to transfer rotation from mud motor 46 through mandrels 70, 90 to bit 14 while allowing lower mandrel 90 the ability to move axially relative to upper mandrel 70. Torque coupling 110 includes outer channels 76 that are paired and aligned with inner channels 96, and a plurality of axially extending spline pins 112, one spline pin per pair of channels 76, 96. Spline pins 112 keep the upper and lower mandrels 70, 90 rotationally fixed with respect to one another (i.e. configured to rotate together), while accommodating relative axial movement between the two mandrels. In this way, spline pins 112 allow a hammering effect to be transferred axially between the lower mandrel and upper mandrel 70, and the hammering effect is further transferred to the drill bit and the drill string.

In addition, mandrels 70, 90 are coupled for fluid communication at lower end 72 slidingly received within upper end 94. Mandrels 70, 90 are coupled for axial movement by the alignment of percussion surfaces 78, 98 facing each other. If FIG. 3, percussion surfaces 78, 98 are spaced apart. Clearances and seals between mandrels 70, 90 allow movement while inhibiting the leaking of drilling fluid (mud) that may be inside mandrels 70, 90. During operation of tool 50, percussion surface 98 oscillates axially relative to surface 78, causing surfaces 78, 98 to impact each other periodically transferring an axial impact force between mandrels 70, 90, as is discussed in more detail below.

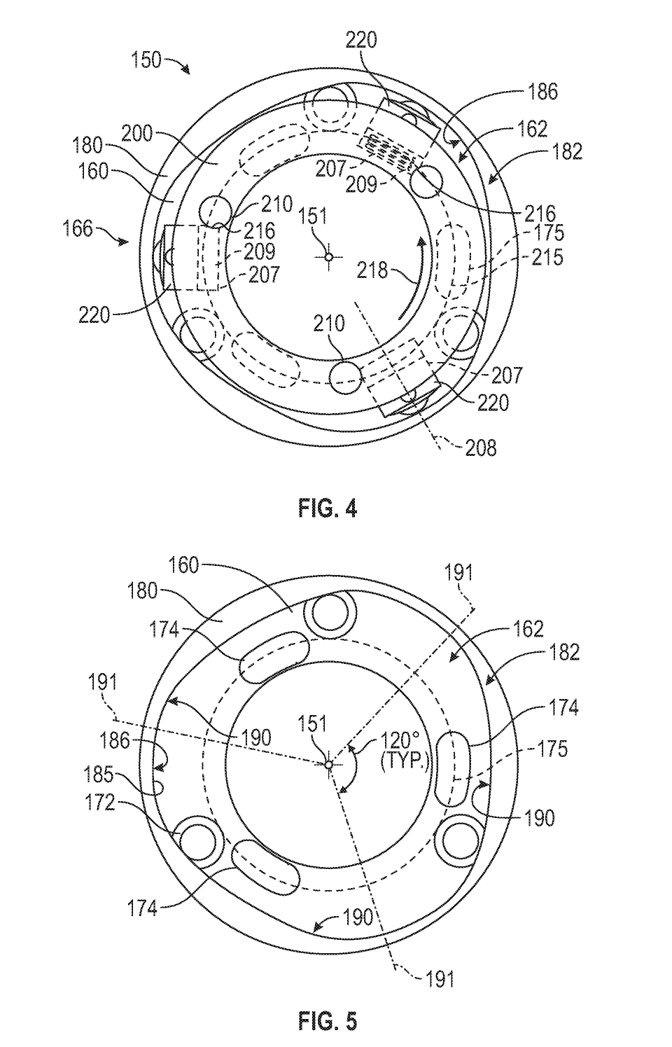

Referring to FIG. 3 and FIG. 4, pump 150 has an annular configuration and includes a longitudinal or central axis 151 aligned with axis 51, a leading or lower end 152, a trailing or upper end 154, an annular valve plate 160 located at upper end 154, a cam ring 180 fixed to and extending axially from plate 160, an annular piston housing 200 set within cam ring 180. Valve plate 160, cam ring 180, and piston housing are 200 are disposed concentrically about axis 151. In FIG. 4, pump 150 is shown alone, not installed within tool 50.

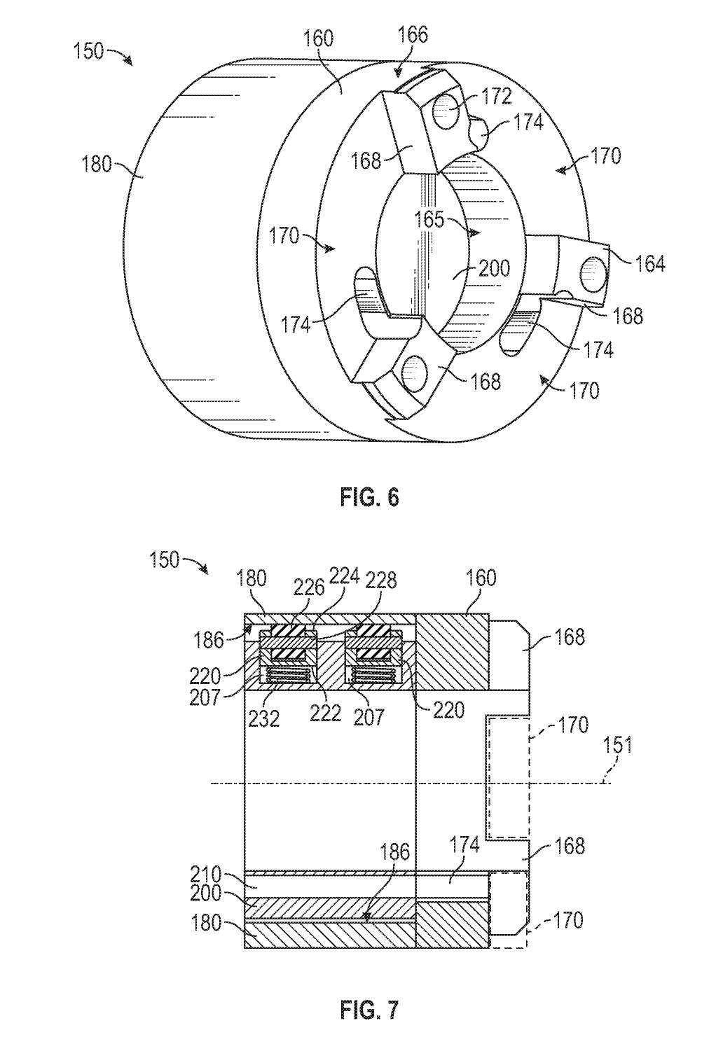

Referring to FIGS. 5 and 6, annular valve plate 160 of pump 150 is sized to extend radially between upper mandrel 70 and BHA tool housing 55, and is separated from upper mandrel 70 by a radial clearance to allow relative rotation therebetween. Valve plate 160 includes a leading or lower end surface 162 positioned adjacent and axially facing the 180, and includes a trailing or upper end 164 disposed against or adjacent the internal shoulder 58 of housing 55. Valve plate 160 also includes a radially inner surface 165 and a radially outer surface 166 sealed against the inner surface of housing 55. The inner and outer surfaces 165, 166 are cylindrical or generally cylindrical. Upper end 164 includes a plurality of axially-extending bosses 168, circumferentially spaced, and a plurality of recesses or reservoirs 170, one reservoir between each neighboring pair of bosses 168. As shown in FIG. 3, the reservoirs 170 extend to the housing shoulder 58. In the example of FIG. 6, valve plate 160 includes three bosses 168 and three reservoirs 170.

Referring again to both FIG. 5 and FIG. 6, a plurality of counter sunk through-bores 172 extend axially from lower end surface 162 through the bosses 168, one per boss 168, to receive fasteners that couple valve plate 160 to housing 55. Valve plate 160 further includes a plurality of axially-extending through-bores or fluid ports 174 that have an elongate, curved cross-sectional flow area in a plane perpendicular to axis 151 that includes end surface 162. The flow area of each fluid port 174 thus may be described non-circular and, in the example shown, as having a kidney bean shape. Each fluid port 174 extends from end surface 162 into one of the reservoirs 170 for fluid communication. Each reservoir 170 is larger than its mating fluid port 174. Non-circular ports 174 are located proximal the radially inner surface 165 and, in the embodiment shown, are circumferentially spaced apart uniformly along a circle 175 about the axis 151 and are curved along this circle. That is to say, in this embodiment, the radially inner and radially outer edges of ports 174 are parallel to circle 175.

Referring to FIG. 3 and FIG. 5, cam ring 180 includes a leading or lower end surface 182 that faces axially toward the left or “downhole” in FIG. 3, a trailing or upper end surface 184 positioned adjacent and facing axially toward valve plate 160, and an aperture 185 that extends axially through surfaces 182, 184. Cam ring 180 further includes a profiled, inwardly facing camming surface 186 which defines aperture 185. In the circumferential direction, camming surface 186 has a periodically varying radius measured from axis 151. Cam ring 180 and valve plate 160 are axially and rotationally fixed with respect one another and with respect to housing 55. The camming surface 186 has a plurality of cycle-sections 190 contiguous with each other. In the embodiment shown in FIG. 5, the camming surface 186 has three equal-length cycle-sections 190, each cycle-section 190 corresponding to one of the three fluid ports 174 of valve plate 160. As indicated by the two-dimensional tri-axes 191 extending from center 151, each cycle-section 190 extends circumferentially through 120° of camming surface 186 and has an angular alignment about axis 151 (i.e. the position of a starting and an ending point) that corresponds with a fluid port 174. Cycle-sections 190 will be discussed in greater detail below.

Referring to FIG. 3 and FIG. 4, annular piston housing 200 includes leading or lower end surface 202 and trailing or upper end surface 204 axially displaced from the surface 202 and located proximal the lower end surface 162 of valve plate 160. Upper end surface 204 is configured to move relative to and to seal against the valve plate surface 162. Piston housing 200 also includes radially inner surface 205 and a radially outer surface 206. A plurality of bores or “cylinders” 207, each configured to receive a piston, extends inward from the outer surface 206, each having a central axis 208 that extends radially with respect to pump axis 151. In the embodiment of FIG. 4, housing 200 is formed as unitary member, but made be formed from multiple pieces joined together. Best shown in FIG. 4, a plurality of an axially-extending fluid passages or ports 210 pass entirely through piston housing 200 from surface 202 to surface 204. Ports 210 are located proximal the radially inner surface 205 and are circumferentially spaced apart uniformly along a circle 215 about the axis 151. Circle 215 has the same diameter as circle 175 of valve plate 160. Each fluid port 210 intersects the edge of at least one of the radially-extending cylinders 207 to allow fluid communication; the intersection is indicated by reference numeral 216. Thus, the fluid port 210 and the cylinder 207 that it intersects are essentially tangent to one other, with a slight overlap. In the view of FIG. 4, intersections 216 are located on the right side of each cylinder 207. The right side is the trailing-side of the cylinder 207 since piston housing 200 rotates counter clockwise with respect to cam ring 180 and valve plate 160 in the view of FIG. 4, as indicated by rotation arrow 218. In the embodiment of FIG. 3 and FIG. 4, piston housing 200 has three fluid ports 210; each port has a round cross-sectional flow area parallel to surfaces 202, 204. Each port 210 is radially positioned to align for fluid communication with each of the axially-elongate fluid ports 210 on valve plate 160 in sequence, when piston housing 200 rotates relative to valve plate 160.

Referring now to FIG. 4 and to FIG. 7, piston housing 200 includes six of the cylinders 207 and each bore 207 slidingly receives a piston 220 aligned on axis 208, which is configured to reciprocate radially therein. The six pairs of cylinder 207 and piston 220 are axially-separated into two groups or stages of three pairs each. The end view of FIG. 4 shows the first group comprising three piston-cylinder pairs circumferentially spaced by 120°. The second group of three piston-cylinder pairs is axially spaced from the first. The side view of FIG. 7 shows one piston-cylinder pair for each of the two, axially-spaced groups. Within practical limits, other embodiments may have fewer or more axially spaced groups of piston-cylinder pairs, and each group may have fewer or more piston-cylinder pairs than shown in the Figures herein.

The plurality of pistons 220 is coupled within housing 200 and configured for both reciprocal movement relative to housing 200 and for rotational movement along with housing 200 about axis 151 relative to camming surface 186, valve plate 160, and housing 55. Each piston 220 is capable of independent radial reciprocation within its own cylinder 207; however, the camming surface 186 is contoured to drive all the pistons 220 to move in unison, rising and falling together. Thus pump 150 is configured such that the pistons 220 follow the same periodic cycle. Therefore, all pistons 220 discharge fluid simultaneously, and all pistons 220 intake fluid simultaneously. However, in other pump embodiments made in accordance with the teachings herein, pistons 220 may have other camming surfaces configured to drive two or more pistons 200 to follow different or off-set timing cycles, and in such pumps, some of the ports 210 may be configured to be isolated from other ports 210 and to communicate with vale plate ports 174 at different times.

Continuing to reference FIG. 7, each piston 220 includes a bottom end 222, a top end 224, a roller 226 captured within and protruding beyond the top end 224 by an axle 228 that extends parallel to pump axis 151. For each piston 220 positioned within a cylinder 207, a chamber 209 is formed between the bottom end 222 of the piston and the bottom end of the cylinder bore 207. The volume of each chamber 209 varies based on the location of the roller along the camming surface 186. A resilient member, which in this example is a spring 232 located in chamber 209, biases the piston 220 away from the bottom end of the cylinder 207 to assist piston 220 when drawing fluid into the chamber 209.

Referring again to FIG. 3, an actuating annular piston 240, which may also be called an “extension piston,” is coupled the upper end of the lower mandrel 90 and extends around and axially along a portion of the outer surface of upper mandrel 70. In more detail, the annular piston 240 includes a leading or lower end 242, a trailing or upper end 244 with an end surface 245 defined by a prescribed projected surface area, three annular sections: lower section 246 extending from end 242, a central section 252, and an upper section, 255 extending to end 244. The lower section 252 surrounds and threadingly couples to the upper end 94 of the lower mandrel 90, joining these members for axial and rotation movement together. The central section 252 and upper section 255 extend axially along and slidingly engage the outer surface 75 of upper mandrel 70. Thus, an inner surface 253 shared by the central and upper sections 252, 255 seals or nearly seals against upper mandrel 70. An outer surface shared by the lower and central sections 246, 252 has an outer diameter D248 that provides clearance from the inner surface of housing 55. An outer surface 256 of the upper section 255 has an outer diameter D256 that is less than the outer diameter D248 of the lower two portions 246, 252. Consequently, the upper section 255 has a thinner wall thickness than the central section 252 in this embodiment.

A piston seal ring 260 is located in a fixed location within housing 55, surrounding at least a portion of the annular piston's upper section 255 and adjacent lower end 152 of pump 150. The ring 260 includes an axially upper end surface 264, a radially inner surface 266 that slidingly engages the outer surface of the upper section 255 of the annular piston with minimal clearance, and a radially outer surface 268 that seals against the inner surface of housing 55, reducing or preventing fluid from transferring past piston seal ring 260. Upper end surface 264 faces the surfaces 182, 202 of pump 150. An annular chamber 272 is located radially between ring 260 and upper mandrel 70 and axially between upper end surface 245 of piston 240 and pump lower end 152. The volume of chamber 272 varies based on the axial location of piston 240.

Referring to FIG. 3 and FIG. 4, a pumping chamber 280 includes the lower, variable volume portions 209 of all cylinders 207 for pistons 220, includes all fluid ports 210 in piston housing 200, and includes chamber 272. These three portions 209, 210, 272 of pumping chamber 280 are always in fluid communication, throughout all portions of the pumping cycle. As a result, the pistons 220 are always in fluid communication with the actuator or “load” that is being driven by pump 150, which in FIG. 3 is actuating annular piston 240. Pump 150 is configured to move piston 240 and lower mandrel 90 relative to pump 150, upper mandrel 70, and housing 55. This means that in at least some instances, when drill bit 14 engages an earthen formation (FIG. 1), piston 240 and mandrel 90 may remain axially stationary (except for downward cutting action), while pump 150, mandrel 70, housing 55, and/or some of the drill string 8 above these components may be moved upward, away from piston 240 and mandrel 90 by the action of pump 150. Thus, in at least some instances, the load being driven by pump 150 is pump 150, mandrel 70, housing 55, and/or some of the drill string 8 above these components by the periodic expansion of chamber 272. For this disclosed embodiment, no valve is located in the fluid path that exists between pistons 220 and the load that is driven by pistons 220, e.g. piston 240. That is to say there is no valve located within pumping chamber 280, and the fluid communication between pistons 220 and the load is uninterrupted. Equivalently, no valve is located in the fluid path between pump 150 and the load that is driven by pump 150 such that the fluid communication between pump 150 and the load is uninterrupted.

Instead, based on the placement of valve plate 160, the valves of pump 150 are located on an end of pumping chamber 280 that is located opposite piston 240. During pumping operation, as piston housing 200 rotates relative to plate 160 and housing 55, fluid ports 210 periodically align with fluid ports 174 in valve plate 160 so that pistons 220 and piston 240 are periodically in fluid communication with ports 174 and reservoirs 170 that are configured to transfer working fluid or the pressure of the working fluid to and from pumping chamber 280. Ports 174 and solid portions between ports 174 on valves plate 160 serve as the valves of pump 150 to open and close fluid communication with ports 210 of housing 200. Each port 174 provides a bi-directional flow path; that is to be contrasted with other pump valves that allow fluid to flow only in one direction. The rotation of piston housing 200 in a single direction relative to valve plate 160 opens and closes the valves of plate 160. The valves may remain stationary relative to their surroundings, such as borehole 8, even as the valves open and close the fluid passage that includes pumping chamber 280 leading to the pistons 220. In effect, the valves of pump 150 move in a single rotational direction and do not reciprocate as is common in many other pump designs. In the embodiment shown, the valves of pump 150 are timed and operated based that rotational movement and are not operated by a pressure or suction developed within pump 150. For ease of discussion, valve plate 160 may also be called the valve (singular) of pump 150; although it includes multiple valves or regions functioning as valves.

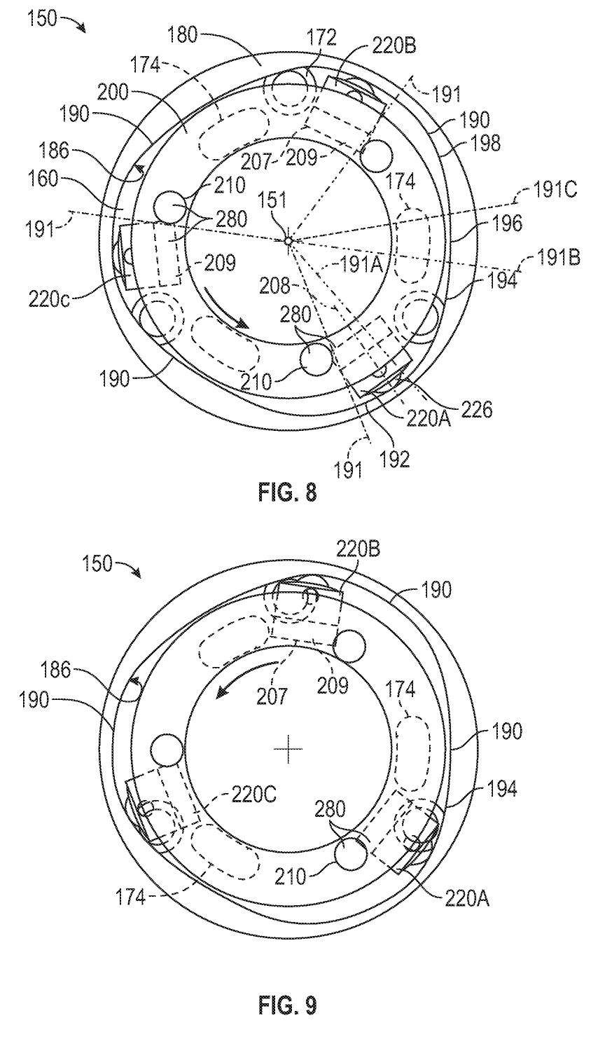

Referring to FIG. 8 and again considering cam ring 180, each cycle-section 190 of camming surface 186 is configured to move or to guide a piston 220 to travel radially through complete extension and retraction cycle with respect to the mating cylinder 207 in piston housing 200. In the example shown, camming surface 186 has three cycle-sections 190; therefore, each piston 220 executes three extension and retraction cycles for each full, 360° rotation of housing 200 within cam ring 180. The three sections 190 are separated by the three axes 191. Each section 190 includes a plurality of path segments, which have various effects on the movement of a piston. As an example, a cycle-section 190 shown on the right side of FIG. 8 includes four path segments 192, 194, 196, 198 that are indicated by radial lines 191A, 191B, 191C and the two axes 191 located on either end of that section 190. Sequentially, the path segments of each section 190 include: an outer dwell segment 192, a compression ramp segment 194, an inner dwell segment 196, and an expansion ramp segment 198. The four named path segment are joined to their neighbors by a fillet to provide a smooth transition therebetween. The dwell segments 192, 196 of the camming surface 186 follow a constant radius, circular path centered on axis 151, and ramp segments 194, 198 each follow a spline curve. In some embodiments, the shape of the spline curves for segments 194, 198 are similar; in other embodiments, the shapes differ.

In one exemplary pumping operation, each of the three round passages 210 of piston housing 200 periodically align with and disengage from each of the three circumferentially-elongate fluid ports 174 of valve plate 160. For each successive one-third rotation, each round port 210 aligns with another port 174 in sequence. FIG. 8 through FIG. 13 shows the cycles of three circumferentially-spaced pistons 220A, B, C during a single one-third revolution of piston housing 200 about axis 151 with respect to camming surface 186. Thus, in FIGS. 8-13, each piston 220A, B, C remains within a single cycle-section 190. Referring to FIG. 7, each piston 220A, B, C is paired with another, aligned piston 220, spaced apart along axis 151. For simplicity, the following discussion will refer to the single piston 220A, but the discussion equally applies to each of the three pistons 220A, B, C, simultaneously, and to their axially-aligned partners. In FIG. 8, roller 226 of piston 220A is traveling along an outer dwell segment 192 of a cycle-section 190, and the coupled housing port 210 is aligned with a solid portion of the valve plate 160 and is not aligned with any fluid port 174. In this condition, pumping chamber 280 and actuating annular piston 240 are isolated from ports 174 and reservoirs 170 such that, during this part of the cycle, chamber 280 is closed at one end by valve plate 160. In FIG. 9, roller 226 begins to traveling along a compression ramp segment 194, and piston 220 travels inward toward pump axis 152 along cylinder axis 208 and begins to compress the working fluid in pumping chamber 280, pushing annular piston 240 and lower mandrel 90 away from upper mandrel 70 and leftward (in FIG. 3) with respect to housing 55. Actually, when in a borehole with the bottom of drill bit 14 contacting a formation, piston 240 and mandrel 90 may remain in-place while upper mandrel 70 and a portion of tubular string 8 are pushed upward.

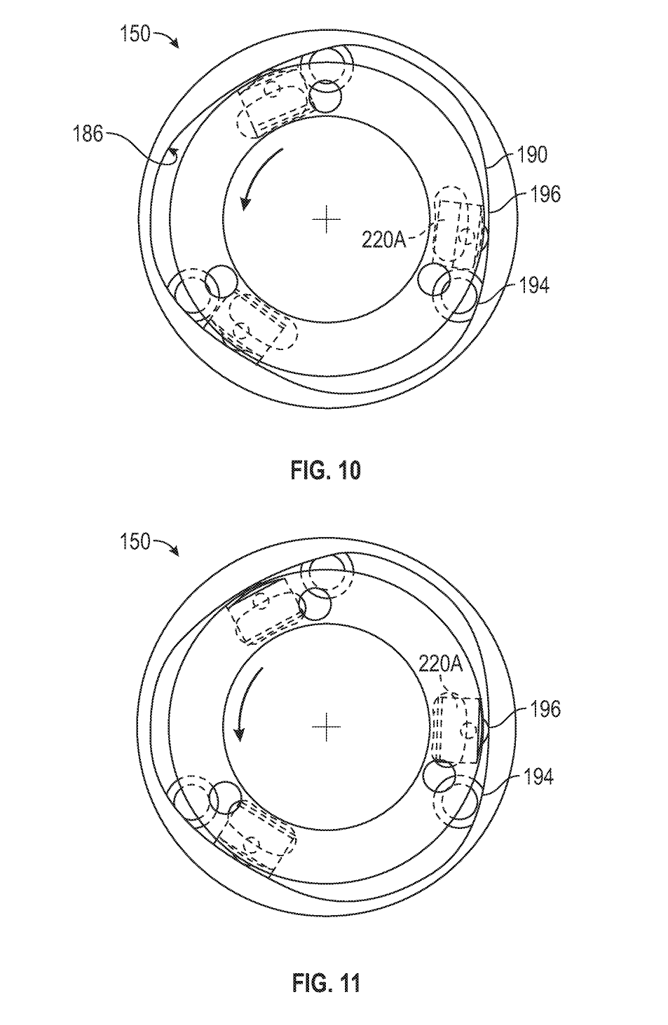

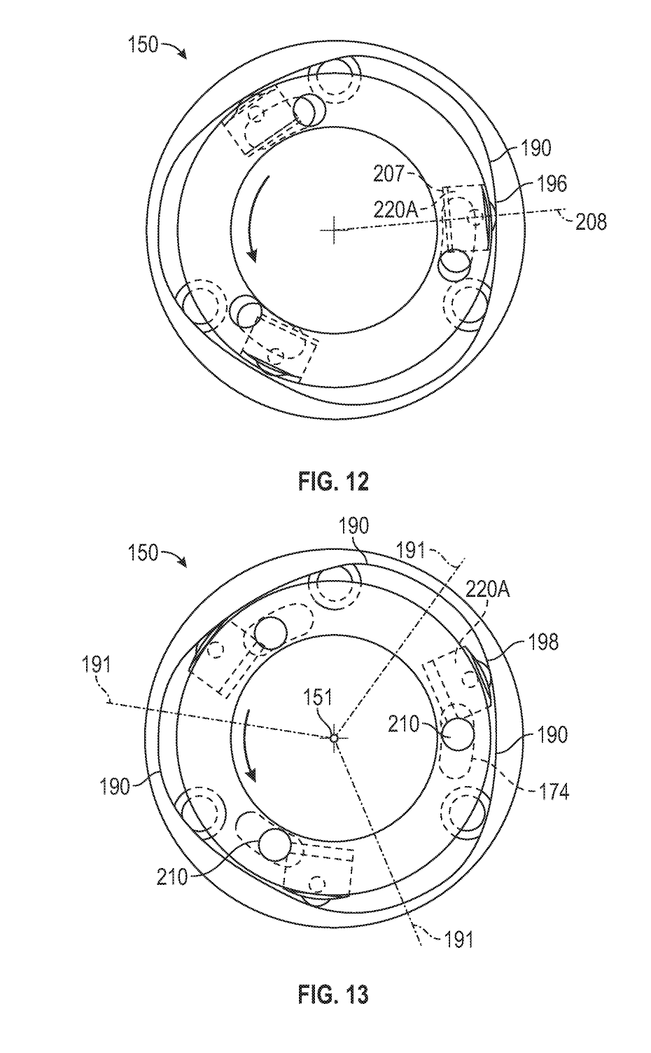

In FIG. 10, the compression is nearly complete, and port 210 is still isolated from all fluid ports 174. During this time period, piston 240 and lower mandrel 90 reach their greatest axial distance from upper mandrel 70 (not shown). Referring now to FIG. 11, as rotation continues, port 210 begins to align with a fluid port 174 and roller 226 moves from compression ramp segment 194 to inner dwell segment 196 on camming surface 186. FIG. 12 shows further progress with port 210 almost fully aligned with a portion of circumferentially-elongate port 174, and roller 226 traveling along inner dwell segment 196 so that piston 220 does not move in or out along axis 208 during this period. The initial alignment of ports 210, 174 allows or causes compressed or pressurized working fluid in pumping chamber 280 to flow into port 174 and the coupled reservoir 170. The rapid departure of fluid or fluid pressure from annular chamber 272 adjacent piston 240 (FIG. 3) causes upper mandrel 70 and tubular string 8 to collapse relative to the piston 240 and lower mandrel 90, causing percussion surfaces 78, 98 (FIG. 3) to impact each other, creating an impact force felt along at least a portion of tubular string 8 and bit 14 (FIG. 1), when attached. For an incompressible working fluid, this initial fluid communication between pumping chamber 280 and fluid port 174 at least transfers fluid pressure therebetween. The fixed position of piston 220 in cylinder 207 during travel along the inner dwell segment 196, does not allow fluid to return to piston chamber 209.

In FIG. 13, as port 210 (representing pumping chamber 280) continues to communicate with circumferentially-elongate port 174 in valve plate 160, roller 226 reaches and travels along expansion ramp segment 198 allowing piston 220 to move outward along cylinder axis 208, causing piston chamber 209 to expand and draw-in fluid from reservoir 170 through valve plate 160 and, possibly from annular chamber 272 adjacent piston 240 (FIG. 3). The outward movement of piston 220 is driven by the force of spring 232 beneath the piston or by the pressure of the fluid. The single valve that comprises the aligned port 174 provides, in sequence, fluid flow both to and from the aligned fluid port 210 and its pumping chamber 280 without closing or losing fluid communication between these two events. (The other aligned ports 174 perform the same dual-task, providing bi-direction fluid communication.) Thus, within the periods of inner dwell segment 196 and expansion ramp segment 198, valve plate 160 allows bi-direction flow or pressure transfer between pumping chamber 280 and reservoir 170 without losing fluid communication between the period of out-going and the period of incoming exchange. Although, ports 240 may periodically overlap with portions of through-bores 172 as housing 200 rotates, bores 172 do not provide fluid communication out of pump 150 at least due to the fasteners received within bores 172.

As a reminder, in the embodiment thus described, all three pairs of elongate and round fluid ports 174, 210 align simultaneously during the operational stages shown in FIG. 11 to FIG. 13 and all pistons 220 move in unison throughout the cycle. As piston housing 200 continues to rotate, roller 226 moves from expansion ramp segment 198 to the outer dwell segment 192 of the next cycle-section 190 of camming surface 186 and the piston's cycle repeats the pattern of FIG. 8 through FIG. 13. The pumping cycle is repeated three times for each rotation of the inner and outer mandrels with respect to housing 55. Depending on the diameter of pump 150, the sizes of the pistons 220, or other factors, more or fewer pumping cycles per revolution can be achieved by including additional or fewer fluid ports 174 in valve plate 160 and, optionally, by including additional or fewer cylinders 207 and pistons 220 in housing 200.

### Another Exemplary Embodiment

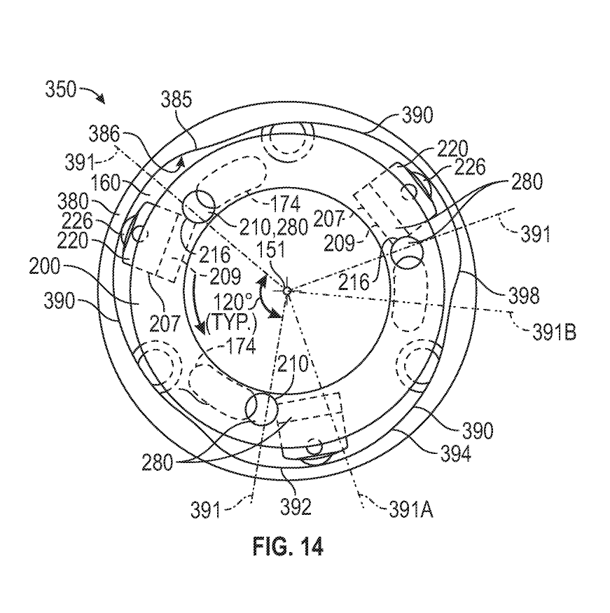

Referring to FIG. 14, in another embodiment, a pump 350 is compatible with percussion tool 50 and well system 1. Pump 350 shares similarities with pump 150 as described above; however, pump 350 includes a different camming surface and, in at least one embodiment, does not include springs to drive the up-stroke of the pistons. Pump 350 includes various features similar or identical to those previously disclosed, including longitudinal or central axis 151, an annular valve plate 160, annular piston housing 200, and at least one piston 220. Annular valve plate 160 includes the features previously described, such as: at least one reservoir 170 coupled for fluid communication to at least one fluid port 174. Like the reservoirs 170 shown in FIG. 6 and FIG. 7, so also in pump 350, valve plate 160 includes three reservoirs 170 coupled to three ports 174 that are circumferentially spaced by 120°. Annular piston housing 200 includes features previously described, such as: at least one radially extending bore or cylinder 207 coupled for fluid communication to at least one axially-extending fluid passage or port 210, joined at an intersection 216. The at least one piston 220 is slidingly received within the at least one cylinder 207, forming a chamber 209 at the bottom end of the cylinder bore 207, including the intersection 216. Again in this embodiment, piston housing 200 includes six pairs of cylinder 207 and piston 220 that are separated into two groups of three pairs each. The end view of FIG. 14 shows the first group comprising three piston-cylinder pairs circumferentially spaced by 120°. The second group of three piston-cylinder pairs is axially spaced from the first, similar to the arrangement of FIG. 7. Other embodiments of pump 350 may have fewer or more piston-cylinder pair, as previously described.

Referring to FIG. 14 and FIG. 3, pump 350 is configured with a pumping chamber 280 that includes the lower, variable volume portions 209 of all cylinders 207 for pistons 220, includes all fluid ports 210 in piston housing 200, and includes chamber 272. These three portions 209, 210, 272 of pumping chamber 280 are always in fluid communication, throughout all portions of the pumping cycle. The pistons 220 are always in fluid communication with the load that is driven by pump 350, which in FIG. 3 is actuating annular piston 240. During operation, as piston housing 200 rotates, fluid ports 210 periodically align with fluid ports 174 in valve plate 160 so that pistons 220 and piston 240 are periodically in fluid communication with ports 174 and reservoirs 170 that are configured to transfer working fluid or the pressure of the working fluid to and from pumping chamber 280.

Continuing to reference FIG. 14, pump 350 differs from pump 150 in that no resilient members, for example no springs, are included to drive or assist piston 220 to extend radially outward. Instead, a cam ring 380 is coupled to valve plate 160 of pump 350, and cam ring 380 includes an axially-extending aperture 385 defining an inwardly facing camming surface 386 that is configured to allow the pressure of fluid in pumping chamber 280 to drive pistons 220 outward during an appropriate portion of the pumping cycle. Camming surface 386 has three equal-length cycle-sections 390, each cycle-section 390 corresponding to one of the three fluid ports 174 of valve plate 160. As indicated by the tri-axes 391 extending from center 151, each cycle-section 390 extends circumferentially through 120°. Each cycle-section 390 provides a complete pumping cycle for the pistons 220, resulting in three pumping cycles per revolution of housing 200 with respect to cam ring 380.

Each cycle-section 390 of camming surface 386 includes a plurality of path segments, which have various effects on the movement of a piston. Sequentially, the path segments of each section 390 include: an outer dwell segment 392, a compression ramp segment 394, and an expansion ramp segment 398. The starting and ending points of path segments 392, 394, 398 are indicated by radial lines 391A, 391B and the two axes 391 located on either end of that section 390. At least in this embodiment, cycle-section 390 lacks an inner dwell segment between the two ramp segments. The three named path segments are joined by smooth transitions. The curvatures of the ramp sections 394, 398 differ from the curvatures of the ramp segments 194, 198 of camming surface 186. The dwell segment 392 follows a constant radius, circular path centered on axis 151, and ramp segments 394, 398 each follow a spline curve.

During operation of pump 350, each of the three passages or ports 210 of piston housing 200 periodically align with and disengage from each of the three circumferentially-elongate fluid ports 174 of valve plate 160. For each successive one-third rotation, each port 210 aligns with another port 174 and piston roller 226 passes over the corresponding cycle section 390. For simplicity, the following discussion will refer to the single piston 220A, but the discussion equally applies to each of the three pistons 220A, B, C, simultaneously, and to their aligned partners.

Still referencing FIG. 14 and describing the operation of pump 350, as roller 226 of piston 220A travels along an outer dwell segment 392 of cycle-section 390, and the coupled housing port 210 moves from a position aligned with elongate fluid port 174 to a position not aligned and isolated from all fluid ports 174. Thus, in the time period of outer dwell segment 392, pumping chamber 280 and actuating annular piston 240 become isolated from ports 174 and reservoirs 170. Outer dwell segment 392 is physically shorter, representing less time, than the outer dwell segment 192 of cam ring 180 in pump 150. Also, with respect to the location of elongate fluid port 174 in valve plate 160, outer dwell segment 392 begins sooner than does outer dwell segment 192 in pump 150, indicated in FIG. 14 by the proximity of tri-axes 391 to the trailing edges of the ports 174 and in FIG. 5 by the greater distance between tri-axes 191 and the trailing edges of the ports 174.

Following outer dwell segment 392, roller 226 of pump 350 begins to traveling along a compression ramp segment 394, and piston 220 travels inward toward pump axis 152, compressing the working fluid in pumping chamber 280, pushing annular piston 240 and lower mandrel 90 axially away from upper mandrel 70 (FIG. 3). Port 210 remains isolated from all fluid ports 174. The compression period of ramp segment 394 is longer, more gradual than the compression period of compression ramp segment 194 of cam ring 180 in pump 150. At the end of compression ramp segment 394, piston 240 and lower mandrel 90 reach their greatest axial distance from upper mandrel 70.

As rotation of housing 200 in FIG. 14 continues, port 210 begins to align with a fluid port 174, and roller 226 moves from compression ramp segment 394 immediately to expansion ramp segment 398 with no “inner dwell portion,” such as inner dwell segment 196 of cam ring 180, disposed between segments 394, 398. Expansion ramp segment 398 rises more rapidly than expansion ramp segment 198 of pump 150. The initiation of expansion ramp segment 398 in pump 350 immediately after completion of the compression segment 194 and the rapid rise of ramp segment 398 allow or cause compressed or pressurized working fluid from annular chamber 272 adjacent piston 240 to push piston 220 outward, expanding its chamber 209. Movement of piston 220 is not temporarily inhibited by an inner dwell segment 196. The initial alignment of ports 210, 174 at this time allows or causes some of working fluid in pumping chamber 280 to flow into port 174 and the coupled reservoir 170. The rapid departure of fluid or fluid pressure from annular chamber 272 adjacent piston 240 (FIG. 3) causes upper mandrel 70 and tubular string 8 to collapse relative to the piston 240 and lower mandrel 90, creating an impact felt along at least a portion of tubular string 8.

With continued rotation of piston housing 200, roller 226 continues to move along expansion ramp segment 398, and fluid or pressure received in valve port 174 and reservoir 170 may flow back to pumping chamber 280 to be received in chamber 209 or chamber 272. Thus, as roller 228 transitions to and travels along expansion ramp segment 398, the valve that comprises the aligned port 174 bi-directionally communicates both inlet flow or pressure and then outlet flow or pressure with pumping chamber 280, in sequence, without closing between these two events. (The other aligned ports 174 perform the same dual-task, providing bi-direction fluid communication in a single open-close cycle.)

Following expansion ramp segment 398 roller 226 moves to the outer dwell segment 392 of the next cycle-section 390 of camming surface 386, and the piston's pumping cycle repeats. The pumping cycle is repeated three times for each rotation of the inner and outer mandrels with respect to housing 55. More or fewer pumping cycles per revolution can be achieved for pump 350 by including additional or fewer fluid ports 174 in valve plate 160 and, optionally, by including additional or fewer cylinders 207 and pistons 220 in housing 200.

Some pump embodiments having a cam ring 380 also include resilient members to drive the upstroke of pistons 220.

### ADDITIONAL INFORMATION

Referring again to valve plate 160 in FIG. 3 and FIG. 6, in some embodiments, one or more fluid reservoirs 170 are formed entirely within valve plate 160 without extending to housing 55, and in some of these embodiments, elongate fluid ports 174 serve as fluid reservoirs in place of a separate, enlarged cavity or recess. In various embodiments, the only path for fluid communication with fluid reservoirs 170 and fluid ports 174 is through the ends of fluid ports 174 that are adjacent the piston housing 200. In various other embodiments, at upper end 164, fluid reservoirs 170 or fluid ports 174 are interconnected for fluid communication with another zone within tool housing 55. In some embodiments, relative to pump axis 151, the radially inner extent of through-bores 172 for fasteners does not overlap the radially outer extent of the fluid ports 174.

Referring again to FIG. 13, the passages or ports 210 in piston housing 200 have been described as having a round, circular flow area perpendicular to pump axis 151 at a surface of piston housing 200, and the ports 174 in valve plate 160 have been described as having an non-circular flow area perpendicular to axis 151 at a surface of valve plate 160. Even so, in some other embodiments, ports 210 are non-circular or ports 174 round. Referring again to FIG. 3, in various embodiments, like pump 150, in the plane where ports 210, 174 engage or communicate (e.g. the plane of surface 184 or 204), ports 174 have larger cross-sectional flow areas than do ports 210. In some embodiments, in the plane where ports 210, 174 engage or communicate, ports 210, 174 may have equal cross-sectional flow areas. In some embodiments, in the plane of surface 184 or 204 where ports 210, 174 engage or communicate, ports 210 may have larger cross-sectional flow areas than do ports 174.

While exemplary embodiments have been shown and described, modifications thereof can be made by one of ordinary skill in the art without departing from the scope or teachings herein. The embodiments described herein are exemplary only and are not limiting. Many variations, combinations, and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims.

What is claimed is:

1. A percussion tool configured to be coupled to a drill string, the tool comprising:
a housing;
an upper mandrel having at least a first end disposed in the housing;
a lower mandrel having at least a first end disposed in the housing and a second end configured to couple to a drilling tool;
a connector in the housing configured to transfer rotation to the lower mandrel when the upper mandrel is rotated;
an actuating piston in the housing configured to reciprocate axially in the housing and to cause the lower mandrel to reciprocate axially relative to the upper mandrel; and
a pump disposed in the housing and comprising:
a cam ring including an end surface and an aperture having a camming surface;
a valve plate having an end surface disposed opposite the end surface of the cam ring, and having at least one fluid port extending through the valve plate;
a piston housing disposed within the aperture of the cam ring and configured to rotate within the cam ring upon rotation of the upper mandrel, wherein the piston housing comprises at least one fluid passage extending therethrough;
a piston configured to reciprocate within the piston housing;
wherein the at least one fluid passage in the piston housing is configured to alternate between being in fluid communication with the fluid port in the valve plate and being isolated from the fluid port as the piston housing is rotated relative to the cam ring and valve plate.

2. The tool of claim 1 further comprising a roller coupled to the piston and configured to engage the camming surface of the cam ring.

3. The tool of claim 1 wherein the flow port in the valve plate is larger in flow area than the flow area of the fluid passage in the piston housing.

4. The tool of claim 3 wherein the cross-sectional flow area of the fluid port is non-circular in the valve plate.

5. The tool of claim 1 further comprising:
a plurality of fluid ports in the valve plate;
a plurality of fluid passages in the piston housing;
wherein each fluid passage in the piston housing is configured to alternate between being in fluid communication with one of the fluid ports in the valve plate and thereafter being isolated from the same fluid port as the piston housing is rotated relative to the cam ring and valve plate.

6. The tool of claim 5 further comprising:
a variable volume annular chamber disposed between the actuating piston and the piston housing and configured to change volume based on the movement of actuating piston;
wherein the fluid passages of the piston housing extend between the annular chamber and the valve plate; and
wherein the fluid passages provide intermittent fluid communication between the annular chamber and the fluid ports in the valve plate as the piston housing is rotated.

7. The tool of claim 6 wherein the fluid passages provide uninterrupted fluid communication between the piston in the piston housing and the annular chamber and uninterrupted fluid communication between the piston in the piston housing and the actuating piston.

8. A pump comprising:
a cam ring comprising an end surface, an aperture, and a camming surface within the aperture;
an annular valve plate fixed in position with respect to cam ring and having and end surface opposing the end surface of the cam ring, and having at least two fluid ports extending therethrough;
an annular piston housing disposed within the aperture of the cam ring and comprising: a plurality of fluid passages extending through the piston housing, an outer surface, and a plurality of radially extending cylinder bores extending through the outer surface, wherein each cylinder bore is in fluid communication with one of the fluid passages;
a plurality of pistons, each piston slidingly received in one of the cylinder bores and configured to reciprocate radially in the piston housing, each piston defining a variable volume cylinder chamber that is in fluid communication with one of the fluid passages;
wherein the pump is configured such that as the piston housing is rotated relative to the cam ring and valve plate, a first of the fluid passages in the piston housing sequentially aligns with a first of the fluid ports in the valve plate and thereafter aligns with a solid portion of the valve plate such that the fluid passage becomes isolated from fluid communication with all fluid ports of the valve plate.

9. The pump of claim 8 wherein the pump is further configured such that each fluid passage in the piston housing sequentially aligns with each fluid port in the valve plate during repeating pumping cycles, each fluid passage alternating between being in fluid communication with one of the fluid ports followed by being isolated from fluid communication with all the fluid ports.

10. The pump of claim 8 wherein the flow area of each fluid port in the valve plate is larger than the flow area of each fluid passage in the piston housing; and
wherein, as the piston housing is rotated, the flow area of the first fluid passage progressively aligns with a changing portion of the flow area of the first fluid port.

11. The pump of claim 9 wherein the cross-sectional flow areas of the fluid ports are non-circular.

12. The pump of claim 8 further comprising a load driven by the pump wherein, as the piston housing is rotated, the load is always in fluid communication with the pistons via the fluid passages.

13. The pump of claim 12 wherein a path of fluid communication between the pistons and the load is free of valves.

14. The pump of claim 12 wherein the load and the pistons are periodically in fluid communication with the fluid ports of the valve plate via the fluid passages, the fluid communication taking place when the fluid passages align with the fluid ports.

15. The pump of claim 14 wherein each fluid port is configured to provide fluid flow both to and from the aligned fluid passage.

16. The pump of claim 14 wherein each fluid port is configured to provide fluid flow both to and from the aligned fluid passage without losing fluid communication between the time period of flow to the aligned fluid passage and time period of the flow from the aligned fluid passage.

17. The pump of claim 9 wherein the piston housing rotates in a single direction relative to the valve plate.

18. A percussion tool comprising:
a housing;
an upper mandrel having at least a first end disposed in the housing;
a lower mandrel having at least a first end disposed in the housing and a second end configured to couple to a drilling tool;
a connector in the housing coupling the first end of the upper mandrel to the first end of the lower mandrel and configured to transfer rotation to the lower mandrel when the upper mandrel is rotated;
an actuating annular piston in the housing disposed about the upper mandrel and configured to reciprocate axially in the housing and to cause the lower mandrel to reciprocate axially relative to the upper mandrel; and
a pump disposed in the housing and comprising: a cam ring rotationally and axially fixed with respect to the housing, the cam ring including an aperture, a camming surface that defines the aperture, and an axially facing end surface facing in a direction away from the actuating piston;
an annular valve plate rotationally and axially fixed with respect to the housing and disposed about the upper mandrel and having an end surface facing the end surface of the cam ring, and having at least two fluid ports extending axially therethrough;
an annular piston housing disposed within the aperture of the cam ring and disposed about and rotationally fixed to the upper mandrel, the piston housing and the upper mandrel and is configured to rotate within the cam ring upon rotation of the upper mandrel, wherein the piston housing comprises: a plurality of axially-extending fluid passages;
a plurality of pistons disposed in the piston housing and configured to reciprocate radially;
a roller coupled to each piston and configured to engage the camming surface of the cam ring;
wherein each fluid passage in the piston housing is configured to alternate between being in fluid communication with any one of the fluid ports in the valve plate and being isolated from the same fluid port as the piston housing is rotated relative to the cam ring and valve plate.

19. The tool of claim 18 wherein the axially facing flow areas of the fluid ports in the valve plate is larger than the axially facing flow areas of the fluid passages in the piston housing; and
wherein, as the piston housing is rotated, the flow area of each fluid passage progressively aligns with a changing portion of the flow area of the mating fluid port.

20. The tool of claim 19 wherein the cross-sectional, flow areas of the fluid ports are non-circular.

21. The tool of claim 18 wherein a variable volume annular chamber extends between the actuating annular piston and the piston housing and is configured to change volume based on the movement of actuating annular piston;
wherein the fluid passages of the piston housing are disposed between the annular chamber and the valve plate, the fluid passages providing periodic fluid communication between the annular chamber and the sequentially aligned fluid ports in the valve plate.

22. The tool of claim 21 wherein the piston housing further comprises a plurality of radially extending cylinder bores, each cylinder bore receiving and slidingly engaging the one of the pistons therein, each cylinder bore intersecting one of the axial fluid passages; and
wherein the plurality of pistons and the actuating annular piston are always in fluid communication through a variable volume pumping chamber comprising: a lower portion of each cylinder bore; the fluid passages of the piston housing; and the annular chamber.

23. The tool of claim 18 wherein the cam ring is rotationally and axially fixed with respect to the annular valve plate and the housing.

24. The tool of claim 18 wherein the camming surface is configured so that the rollers maintain contact with the camming surface throughout a full 360 degree rotation of the annular piston housing with respect to the cam ring.
